(19) United States
(12) Patent Application Publication
(10) Pub. No.: US 2009/0304946 A1
(43) Pub. Date: Dec. 10, 2009

(54) MANUFACTURING METHOD FOR MULTISTAGE ADHESIVE APPLYING AND MULTICOLOR FLOCKING, AND APPARATUS SPECIFICALLY DESIGNED THEREFOR

(76) Inventor: Kaixing Xie, Fujian (CN)

Correspondence Address: DAVID AND RAYMOND PATENT FIRM, 108 N. YNEZ AVE., SUITE 128, MONTEREY PARK, CA, 91754, US

(21) Appl. No.: 12/448,079

(22) PCT Filed: Dec. 3, 2007
(86) PCT No.: PCT/CN2007/003416

§ 371 Date: Jun. 5, 2009

(30) Foreign Application Priority Data
Dec. 6, 2006 (CN) 200610135290.6

(51) Int. Cl. B05D 1/16; B05B 5/025

(52) U.S. Cl. 427/462; 118/624

(57) ABSTRACT

A manufacturing method for multistage adhesive applying and color separation flocking, and a device specifically used therefor are disclosed. The manufacturing method comprises: (1) dividing multistage adhesive applying and flocking zones according to several blocks in different colors of a product; (2) drying and air cooling after each register adhesive applying and color separation flocking process, to form a manufacturing unit for completing one color flocking; (3) arranging successively several sets of manufacturing units according to the number of blocks in different colors; (4) starting from the first color, register adhesive applying, color separation flocking, drying and air cooling successively within respective positions of each manufacturing unit on the base cloth to be printed; (5) performing only register adhesive applying in the manufacturing unit for the last color, while performing flocking, drying and air cooling by a conventional flocking production line to cooperate therewith. The device specifically used comprises a driving mechanism for base cloth to be printed, characterized in that several sets of multistage adhesive applying, flocking, drying and air cooling apparatuses are successively arranged thereon.

### BACKGROUND OF THE PRESENT INVENTION

1. Field of Invention

The present invention relates to a manufacturing method for multistage adhesive applying and color separation flocking, and the device specifically used therefor.

2. Description of Related Arts

In the prior art, the inventor filed a patent application NO. 200620086532.2 for a utility model entitled “Device for Printing and Flocking Adhesive Applying” on Jun. 29, 2006. The device according to patent application for the utility model can well function to complete production processes of registration printing and register flocking adhesive applying for flocking cloth to be printed and flocked, and can be arranged directly on an existing continuous flocking production line. However, the device will not accomplish so if a positioning color separation flocking is required within a flocking position. The positioning color separation flocking within the flocking position refers to a pattern formed of floss in different colors with distinct boundaries therebetween in the respective specified areas of a pattern within a flocking pattern combination according to design requirements. For example, in accordance with the design requirements, in a pattern combination comprising several patterns, one pattern thereof is specified to be formed of green floss, another is specified to be formed of red floss, and the remaining ones are specified to be formed of floss in other colors; or several petals in a pattern are green, several are red, and the remaining are in other colors. For another example, in a flocking pattern of a panda, the portions of the eye sockets, a ring around the neck and four legs are, as required, formed of black floss the rest are formed of white floss, with clear and distinct boundaries therebetween. Such a category as described above is of the positioning color separation flocking within the flocking position. In the prior art, continuous mechanized production is still impossible on a continuous flocking production line.

### SUMMARY OF THE PRESENT INVENTION

An object of the present invention is to provide a manufacturing method for multistage adhesive applying and color separation flocking, and a device specifically used therefor. The method and the device specifically used therefor may not only perform a positioning multistage flocking adhesive applying and a color separation flocking within a flocking position, but also are directly arranged on an existing continuous flocking production line, such that the mechanized continuous production of highly difficult positioning color separation flocking cloth products of multicolor flocking comes into reality.

A manufacturing method for multistage adhesive applying and color separation flocking according to the present invention is characterized by: (1) dividing, correspondingly, multistage adhesive applying and flocking zones on base cloth to be printed in accordance with several blocks in different colors and positions thereof in a color separation flocking cloth product; (2) performing drying and air cooling processing after each register adhesive applying and color separation flocking process, to form a manufacturing unit for completing one color flocking; (3) equipping a driving mechanism for the base cloth to be printed correspondingly with several sets of register adhesive applying, color separation flocking, drying and air cooling apparatuses successively along a horizontal direction according to the number of blocks in different colors, wherein the manufacturing unit for a last color block is only provided with a register adhesive applying apparatus, while the remaining flocking, drying and air cooling apparatuses therefor adopt the existing and conventional flocking production line to cooperate therewith; (4) advancing, by the driving mechanism for the base cloth to be printed, the base cloth to be printed along a horizontal direction, and performing a first register adhesive applying when it arrives at a first adhesive applying apparatus station; followed by a first drying processing and the first air cooling processing, performing a first register color separation flocking when it arrives at a first color separation flocking station, and, along the driving mechanism, entering into a next round of register adhesive applying, color separation flocking, drying and air cooling processing; (5) performing a last register adhesive applying when the base cloth to be printed, along the driving mechanism, comes into the manufacturing unit for the last color block, while performing the remaining flocking, drying, cooling processing by means of the existing and conventional flocking production line to cooperate therewith; and completing the whole production process after brushing and wrapping up.

A device specifically used for the manufacturing method for multistage adhesive applying and color separation flocking according to the present invention comprises a driving mechanism for base cloth to be printed, characterized in that the driving mechanism is provided thereon with several sets of multistage adhesive applying, flocking, drying and air cooling apparatuses successively, wherein the multistage adhesive applying, flocking, drying and air cooling apparatuses are rotary screen flocking adhesive applying apparatus, color separation flocking apparatus, hot-air drying apparatus and air cooling apparatus that are disposed successively along the driving mechanism, and a cloth output end of the driving mechanism is provided with a last set of rotary screen flocking adhesive applying apparatus.

The production performed according to the present invention mainly features in a multistage adhesive applying and color separation flocking, which is characterized not only by accurate print register, but also by clear and distinct boundaries between blocks in different colors of multicolor flocking cloth products. The present invention can fulfill the production of positioning color separation flocking cloth, a superior product requiring high technique of production, in a well qualified and highly efficient manner, thereby meeting the demand of markets at home and abroad and receiving remarkable benefits.

These and other objectives, features, and advantages of the present invention will become apparent from the following detailed description, the accompanying drawings, and the appended claims.

### BRIEF DESCRIPTION OF THE DRAWINGS

FIG. 1 is a schematic structural diagram of a production apparatus at a cloth input end according to a first embodiment of the present invention.

FIG. 2 is a schematic structural diagram of a production apparatus at the cloth output end according to the first embodiment of the present invention.

FIG. 3 is a schematic structural diagram of a color separation flocking apparatus according to the present invention.

FIG. 4 is a schematic structural diagram of a production apparatus at the cloth input end according to a second embodiment of the present invention.

FIG. 5 is a schematic structural diagram of a production apparatus at the cloth output end according to the second embodiment of the present invention.

In the figures, 1 refers to a base cloth that is subjected to multistage adhesive applying and color separation flocking; 2 refers to a set of rotary screen printing apparatus; 3 refers to a first set of rotary screen flocking adhesive applying apparatus; 4 refers to a first set of color separation flocking apparatus; 5 refers to a driving mechanism for the base cloth to be printed; 6 refers to a first set of hot-air drying apparatus; 7 refers to a first set of air cooling apparatus; 8 refers to a second set of rotary screen flocking adhesive applying apparatus; 9 refers to a second set of color separation flocking apparatus; 10 refers to a second set of hot-air drying apparatus; 11 refers to a second set of air cooling apparatus; 12 refers to a third to n-th sets of rotary screen flocking adhesive applying apparatuses, color separation flocking apparatuses, hot-air drying apparatuses and air cooling apparatuses; 13 refers to a last set of rotary screen flocking adhesive applying apparatus; 14 refers to tensioning driving wheels at front and rear ends; 15 refers to a lifting operating air cylinder of a hot-air drying apparatus; 16 refers to a rack; 17 refers to a negative high voltage electrode grid; 18 refers to a noil groove; 19 refers to a ground electrode; 20 refers to a first set of brush washing box; 21 refers to a set of resin scraping knife; 22 refers to a set of spray sponge scrubbing apparatus; 23 refers to a second set of brush washing box; and 24 refers to a resin applying apparatus for applying resin to guiding belt.

### DETAILED DESCRIPTION OF THE PREFERRED EMBODIMENT

A manufacturing method for multistage adhesive applying and color separation flocking according to the present invention is characterized by the steps: (1) dividing, correspondingly, multistage adhesive applying and flocking zones on base cloth to be printed in accordance with several blocks in different colors and positions thereof in a color separation flocking cloth product; (2) performing drying and air cooling processing after each register adhesive applying and color separation flocking process, to form a manufacturing unit for completing one color flocking; (3) equipping a driving mechanism for the base cloth to be printed correspondingly with several sets of register adhesive applying, color separation flocking, drying and air cooling apparatuses successively along a horizontal direction according to the number of blocks in different colors, wherein the manufacturing unit for a last color block is only provided with a register adhesive applying apparatus, while the remaining flocking, drying and air cooling apparatuses therefore adopt the existing and conventional flocking production line to cooperate therewith; (4) advancing, by the driving mechanism for the base cloth to be printed, the base cloth to be printed along a horizontal direction, and performing a first register adhesive applying when it arrives at a first adhesive applying apparatus station; followed by the first drying processing and the first air cooling processing, performing a first register color separation flocking when it arrives at a first color separation flocking station, and, along the driving mechanism, entering into a next round of register adhesive applying, color separation flocking, drying and air cooling processing; (5) performing a last register adhesive applying when the base cloth to be printed, along the driving mechanism, comes into the manufacturing unit for the last color block, while performing the remaining flocking, drying, cooling processing by means of the existing and conventional flocking production line to cooperate therewith; and completing the whole production process after brushing and wrapping up.

The above-mentioned register adhesive applying apparatus, i.e., the rotary screen flocking adhesive applying apparatus may be replaced directly with a rotary screen printing apparatus.

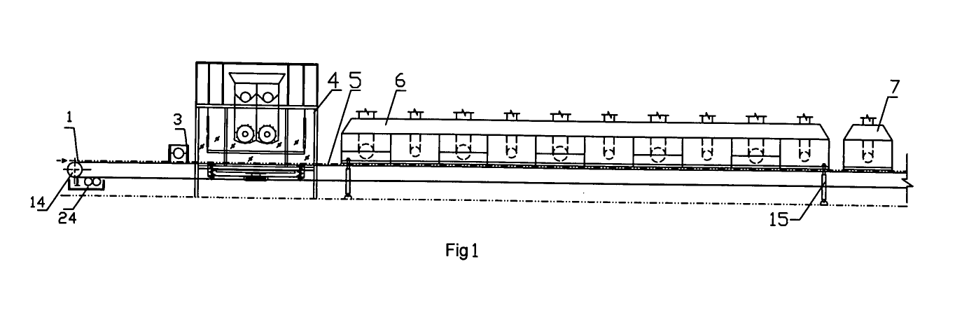

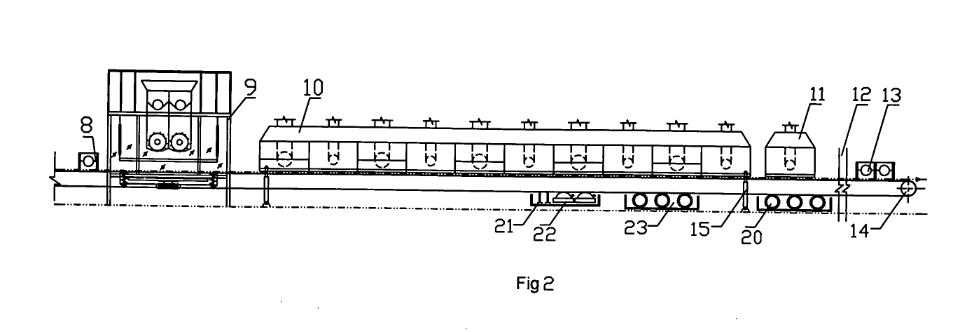

The device specifically used for the manufacturing method of multistage adhesive applying and color separation flocking according to the first embodiment of the present invention (as shown in FIGS. 1, 2 and 3) comprises a driving mechanism for base cloth to be printed, characterized in that the driving mechanism is provided thereon with several sets of multistage adhesive applying, flocking, drying and air cooling apparatuses successively, the multistage adhesive applying, flocking, drying and air cooling apparatuses being rotary screen flocking adhesive applying apparatus, color separation flocking apparatus, hot-air drying apparatus and air cooling apparatus that are arranged successively along the driving mechanism, a cloth output end of the driving mechanism being provided with a last set of rotary screen flocking adhesive applying apparatus.

To achieve coordinated operation and reliable precision of the device, the driving mechanism for the base cloth to be printed includes front and rear driving wheels and an annular rubber guiding belt. The annular rubber guiding belt is 2 mm-4 mm in thickness, 1.6 m-3.8 m in width, and 60 m-120 m in perimeter.

To achieve the continuous production of multistage adhesive applying and color separation flocking, each of the first set to the n-th sets, or even the last set of rotary screen flocking adhesive applying apparatuses is composed of 1 to 2 rotary screen flocking adhesive applying apparatuses. Each of the first to the n-th sets of color separation flocking apparatuses is composed of a rack, a noil groove and a negative high voltage electrode grid arranged therewithin, and a ground electrode located below the cloth feeder of the driving mechanism, wherein the rack is used to support the noil groove and the negative high voltage electrode grid, and to enclose the flocking chamber so as to prevent the floss from flying around, and wherein the rack is 2.4 m-4.6 m in width, 2 m-4 m in length, and 2 m-3 m in height, the width of which should span the feeder rack.

To pre-dry the color separation flocking portion of the base cloth to be printed in time so as to meet the process requirements of the next flocking adhesive applying and color separation flocking, each of the first to the n-th sets of hot-air drying apparatuses is composed of 4 to 16 sets of far infrared electrical heating appliances or vapor radiators or heat conductive oil radiators, a fan and a rack, with a heating surface of 1.4 m-3.2 m in width and 5 m-20 m in length, and a spacing between the heating appliances and the upper surface of the rubber guiding belt of 50 mm-200 mm.

To flexiblely change the upper and lower position of the hot-air drying apparatus, the hot-air drying apparatus is provided with a lifter.

To lift the entire hot-air drying apparatus in time, the lifter is a lifting operating air cylinder.

To lower the surface temperature of the base cloth to be printed that is hot-air dried so as to meet the requirements of the cloth surface temperature in the next multistage flocking adhesive applying, air cooling apparatus is arranged after each set of the hot-air drying apparatuses, wherein each of the first to the n-th sets of the air cooling apparatuses is composed of a fan and a fan cover.

The above-mentioned color separation flocking apparatus includes a rack, a noil groove located at the center of the rack, a negative high voltage electrode grid located below the noil groove and a ground electrode located below the cloth feeder of the driving mechanism.

After the positioning color separation flocked base cloth is output at the cloth output side (the rear end) of the rubber guiding belt, a large amount of pollutants such as adhesive or floss adhere to the belt surface; the lower part of the prolate annular rubber guiding belt needs to be washed and scrubbed for several times, and water on the belt surface is then wiped-up. Each of the first and second sets of brush washing boxes includes 2 to 4 rigid bristle brushes, a spray hose, a stainless steel housing and a motor; the set of spray sponge scrubbing apparatus includes 2 to 4 wearable sponges, a spray hose and a stainless steel frame; the set of resin scraping knife includes 1 to 2 wearable urethane resin scraping knives and a stainless steel frame.

To keep the base cloth to be printed flat on the guiding belt, the belt interlining resin applying apparatus includes a rubber roller applied with resin, a resin scraping knife and a stainless steel housing.

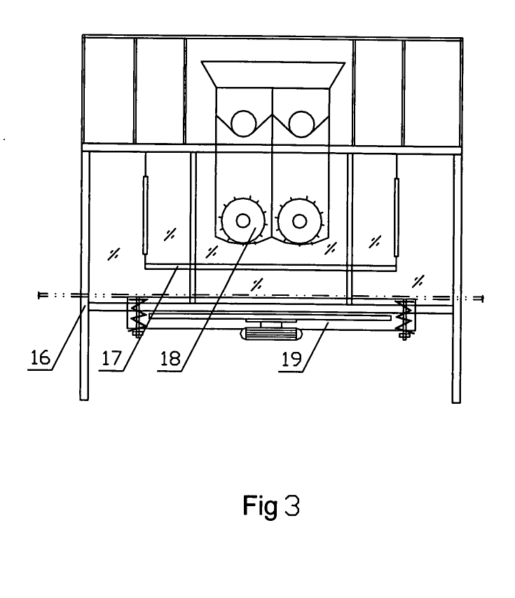

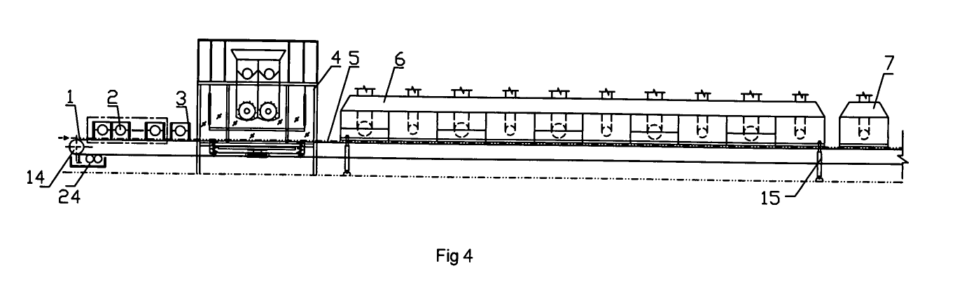

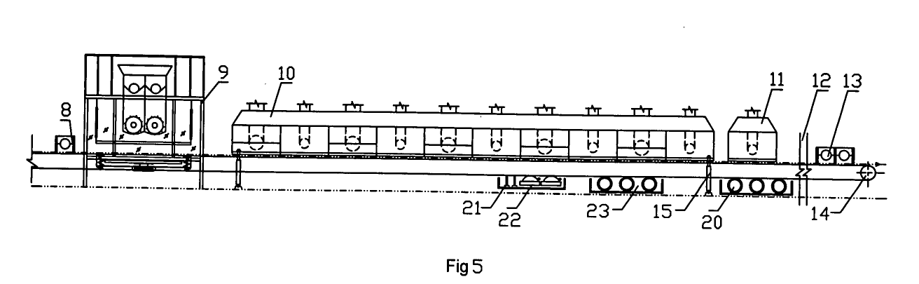

The second embodiment of the present invention (as illustrated in FIGS. 3, 4 and 5) differs from the first embodiment in that the cloth input end of the driving mechanism is provided with a rotary screen printing apparatus thereon. In order to achieve the continuous production of registration printing, the set of rotary screen printing apparatus includes 1 to 12 rotary screen printing apparatuses.

The second embodiment of the present invention is compatible with the production of two categories of products, whereas the first embodiment of the present invention may produce only the first category of products. The first category of products are positioning color separation flocking products, and the second kind of products are dye print or paint print and positioning color separation flocking products. The process flow for producing the first category of products is as follows: cloth feeding→flocking adhesive applying→color separation flocking→hot-air drying→air cooling→flocking adhesive applying→hot-air drying→air cooling→last flocking adhesive applying→cloth output→entering into a configured ordinary flocking production line to complete the last flocking, and eventually producing the positioning color separation flocking cloth product after drying, cooling, brushing and wrapping up. The process flow for producing the second category of products is as follows: cloth feeding→rotary screen chromaticity printing→hot-air drying→air cooling→flocking adhesive applying→color separation flocking→hot-air drying→air cooling→last flocking adhesive applying→cloth output→entering into a configured ordinary flocking production line to complete the last flocking, and eventually producing the dye or paint print and positioning color separation flocking cloth product after drying, cooling, brushing and wrapping up. In the production process, the base cloth to be printed clings to the upper surface of the rubber guiding belt of the driving mechanism and is delivered continuously from the front end to the rear end via the rubber belt; as soon as the base cloth to be printed arrives at the rear end, it is separated from the rubber belt and enters into the next process on the configured ordinary flocking production line so as to complete the whole production process. The rubber belt runs continuously and circularly with the tensioning driving wheels, so that it continuously delivers the base cloth to be printed, resulting in an unintermitted cloth feeding rate (or driving speed) throughout the whole operation process.

The second embodiment of the present invention employs rotary screen printing and multistage flocking adhesive applying, color separation flocking, multistage drying and cooling. During the continuous production, owing to reasonable design of all processes, technical conditions and production factors for the respective processes are met, such that continuous mechanized production of high-level flocking cloth products of multicolor chromaticity registration printing and multicolor chromaticity positioning color separation flocking can be ideally implemented. Compared with the existing technologies, the present invention enjoys the significant advantages as follows: 1. continuous mechanized production is implemented for the high-level flocking cloth products of multicolor chromaticity registration printing and multicolor chromaticity positioning color separation flocking; 2. as the high-level flocking cloth products produced according to the method of the present invention are decorative fabrics and garment fabrics that are very popular in the markets at home and abroad, the continuous mechanized mass production according to the method of the present invention can meet the demands of a variety of consumers at home and abroad.

The specific structural features of the second embodiment according to the present invention include, a set of rotary screen print apparatuses 2, a first set of rotary screen flocking adhesive applying apparatus 3, a first set of color separation flocking apparatuses 4, a first set of hot-air drying apparatuses 6, a first set of air cooling apparatuses 7, a second set of rotary screen flocking adhesive applying apparatus 8, a second set of color separation flocking apparatuses 9, a second set of hot-air drying apparatuses 10, a second set of air cooling apparatuses 11, a third to n-th sets of rotary screen flocking adhesive applying apparatuses, color separation flocking apparatuses, hot-air drying apparatuses and air cooling apparatuses 12, a last set of rotary screen flocking adhesive applying apparatus 13 are successively disposed from the cloth input side (the front end) to the cloth output side (the rear end) on the prolate annular rubber guiding belt 5 used for delivering the base cloth 1 that is subjected to registration printing, multistage adhesive applying and color separation flocking; wherein the set of rotary screen print apparatus 2 includes 1 to 12 ordinary rotary screen print apparatuses; the first, the second to the last sets of rotary screen flocking adhesive applying apparatuses include 1 to 2 rotary screen flocking adhesive applying apparatuses respectively; the first, the second to the n-th sets of color separation flocking apparatuses respectively include a rack 16, a negative high voltage electrode grid 17, a noil groove 18 and a ground electrode 19; and the first, the second to the n-th sets of hot-air drying apparatuses include 4 to 16 sets of temperature adjustable far infrared electrical heating appliances or hot-air drying apparatuses that employ vapor radiator or heat conductive oil radiator respectively, wherein the hot-air drying apparatuses are supported by a air cylinder 15. During operation, the heating surface is separated from the upper surface of the rubber belt 5 adjustable in the range from 50 mm to 200 mm; upon a shutdown or an emergent stop, the cylinder 15 of the apparatus will immediately lift the entire hot-air drying apparatus, such that the spacing between its heating surface and the upper surface of the rubber belt 5 is adjustable in the range from 500 mm-1000 mm. The first, the second to the n-th sets of air cooling apparatuses include a fan and a fan cover. The prolate annular rubber belt 5 are mounted in a prolate annular shape, and are tensioned forwardly and backwardly respectively by the tensioning driving wheels 14 arranged at the front and rear ends therewithin and are driven in a fixed direction, wherein the prolate annular shape is generally 300 mm-600 mm in height and generally 30 m-60 m in length, and the rubber belt is generally 60 m-120 m in perimeter, generally 1.6 m-3.8 m in width, and generally 2 mm-4 mm in thickness.

One skilled in the art will understand that the embodiment of the present invention as shown in the drawings and described above is exemplary only and not intended to be limiting. It will thus be seen that the objects of the present invention have been fully and effectively accomplished.

Its embodiments have been shown and described for the purposes of illustrating the functional and structural principles of the present invention and is subject to change without departure from such principles. Therefore, this invention includes all modifications encompassed within the spirit and scope of the following claims.

1-6. (canceled)

7. A manufacturing method for multistage adhesive applying and color separation flocking, comprising the steps of:
(1) dividing, correspondingly, multistage adhesive applying and flocking zones on base cloth to be printed in accordance with several blocks in different colors and positions thereof in a color separation flocking cloth product;
(2) performing drying and air cooling processing after each register adhesive applying and color separation flocking process, to form a manufacturing unit for completing one color flocking;
(3) equipping a driving mechanism for the base cloth to be printed correspondingly with several sets of register adhesive applying, color separation flocking, drying and air cooling apparatuses successively along a horizontal direction according to the number of blocks in different colors, wherein the manufacturing unit for a last color block is only provided with a register adhesive applying apparatus, while remaining flocking, drying and air cooling apparatuses therefore adopt the existing and conventional flocking production line to cooperate therewith; and
(4) advancing, by the driving mechanism for the base cloth to be printed, the base cloth to be printed along a horizontal direction, and performing a first register adhesive applying when it arrives at a first adhesive applying apparatus station; followed by a first drying processing and a first air cooling processing, performing a first register color separation flocking when it arrives at a first color separation flocking station, and, along the driving mechanism, entering into a next round of register adhesive applying, color separation flocking, drying and air cooling processing.

8. The manufacturing method according to claim 7, further comprising the step ofthnk:
performing a last register adhesive applying when the base cloth to be printed, along the driving mechanism, comes into the manufacturing unit for the last color block, while performing the remaining flocking, drying, cooling processing by means of the existing and conventional flocking production line to cooperate therewith; and completing the production process after brushing and wrapping up.

9. A device specifically used for the manufacturing method for multistage adhesive applying and color separation flocking according to claim 7, comprises a driving mechanism for a base cloth to be printed, characterized in that the driving mechanism is provided thereon with several sets of multistage adhesive applying, flocking, drying and air cooling apparatuses successively, the multistage adhesive applying, flocking, drying and air cooling apparatuses being rotary screen flocking adhesive applying apparatus, color separation flocking apparatus, hot-air drying apparatus and air cooling apparatus that are arranged successively along the driving mechanism, a cloth output end of the driving mechanism being provided with a last set of rotary screen flocking adhesive applying apparatus.

10. The device specifically used for the manufacturing method for multistage adhesive applying and color separation flocking according to claim 9, characterized in that a cloth input end of the driving mechanism is provided thereon with a rotary screen print apparatus.

11. The device specifically used for the manufacturing method for multistage adhesive applying and color separation flocking according to claim 10, characterized in that the hot-air drying apparatus is provided with a lifter.

12. The device specifically used for the manufacturing method for multistage adhesive applying and color separation flocking according to claim 11, characterized in that the lifter is a lifting operating air cylinder.

13. The device specifically used for the manufacturing method for multistage adhesive applying and color separation flocking according to claim 9, characterized in that the color separation flocking apparatus includes a rack, a noil groove located at a center of the rack, a negative high voltage electrode grid located below the noil groove, and a ground electrode located below a cloth feeder of the driving mechanism.

14. The device specifically used for the manufacturing method for multistage adhesive applying and color separation flocking according to claim 10, characterized in that the color separation flocking apparatus includes a rack, a noil groove located at a center of the rack, a negative high voltage electrode grid located below the noil groove, and a ground electrode located below a cloth feeder of the driving mechanism.

15. The device specifically used for the manufacturing method for multistage adhesive applying and color separation flocking according to claim 11, characterized in that the color separation flocking apparatus includes a rack, a noil groove located at a center of the rack, a negative high voltage electrode grid located below the noil groove, and a ground electrode located below a cloth feeder of the driving mechanism.

16. The device specifically used for the manufacturing method for multistage adhesive applying and color separation flocking according to claim 12, characterized in that the color separation flocking apparatus includes a rack, a noil groove located at a center of the rack, a negative high voltage electrode grid located below the noil groove, and a ground electrode located below a cloth feeder of the driving mechanism.
